(19) United States
(12) Patent Application Publication
(10) Pub. No.: US 2011/0197812 A1
(43) Pub. Date: Aug. 18, 2011

(54) APPARATUS AND METHOD FOR FABRICATING A PHASE-CHANGE MATERIAL LAYER

(76) Inventors: Dong Hyun IM, Hwaseong-si (KR); Ik-Soo Kim, Yongin-si (KR); Sung-Lae Cho, Gwacheon-si (KR); Hyeong-Geun An, Hwaseong-si (KR)

(21) Appl. No.: 12/965,184

(22) Filed: Dec. 10, 2010

(30) Foreign Application Priority Data
Feb. 18, 2010 (KR) 10-2010-0014838

(51) Int. Cl. B05C 11/10

(52) U.S. Cl. 118/696

(57) ABSTRACT

Apparatus for fabricating a phase-change material layer include a process chamber. A first source supplier including a liquid delivery system (LDS) structure is coupled between a tellurium (Te) source container and the process chamber. A second source supplier including a bubbler method structure is coupled between at least one metal organic (MO) source container and the process chamber. Methods are also provided.

### CROSS-REFERENCE TO RELATED APPLICATION

This non-provisional application claims priority under 35 U.S.C. §119 of Korean Patent Application No. 10-2010-0014838, filed on Feb. 18, 2010, the disclosure of which is hereby incorporated by reference in its entirety.

### BACKGROUND

Embodiments of the present invention relate to semiconductor devices including a phase-change material and apparatus and methods for fabrication of such devices.

Semiconductor memory devices, which are used to store data, may be classified into volatile semiconductor memory devices and nonvolatile semiconductor memory devices. A volatile semiconductor memory device may store data through charge or discharge of a capacitor. A volatile semiconductor memory device, such as a random access memory (RAM), may store or read data when power is supplied to the device and lose data when power is not supplied to the device, such as when the power supply is interrupted. Volatile semiconductor memory devices are often used as a main memory of a computer.

A nonvolatile semiconductor memory device may store data even if the power supply is interrupted. The nonvolatile semiconductor memory device may be used, for example, to store programs and data for a wide range of applications on computers and portable communication devices.

Owing to the large demand for high-capacity, low-power semiconductor memory devices, research has been conducted on advanced nonvolatile memory devices that do not require refresh operations. Currently, phase-change RAMs (PRAMs) using phase-change materials, resistive RAMs (RRAMs) using variable resistive materials, such as transition metal oxides, and magnetic RAMs (MRAMs) using ferromagnetic materials have attracted considerable attention for use as high-capacity, low-power memory devices. All of these types of advanced memory devices may have variable resistances responsive to applied currents or voltages and may not need refresh operations due to their respective nonvolatile characteristics so that, even if the currents or voltages are no longer applied, these advanced memory devices can maintain resistances corresponding to stored data values in memory cells of the devices.

In the above-described resistive memory device, a unit memory cell may include a single variable resistive device and a single switching device. The variable resistive device may be connected between a bit line and the switching device, while the switching device may be connected between the variable resistive device and a word line. The resistive memory device may include a variable resistive memory cell array having unit memory cells, each unit memory cell having the above-described construction.

Resistive memory devices may be divided into PRAMs, RRAMs, and MRAMs according to the type of a variable resistive device. For example, a PRAM may include, as a variable resistive feature, a phase-change material whose resistance varies with temperature. Also, a RRAM may include, as a variable resistive feature, a device structure having a top electrode, a bottom electrode, and a transition metal oxide disposed therebetween. Furthermore, a MRAM may include as a variable resistive feature a device structure having a top electrode, a bottom electrode, and a magnetic material disposed therebetween.

In a unit memory cell of a PRAM, the film quality of a phase-change material filled between top and bottom electrodes may significantly affect the performance of the PRAM. Thus, an apparatus and method for fabricating a phase-change material with a good film quality may be required.

### SUMMARY

In some embodiments, a method of fabricating a phase-change material includes supplying a tellurium (Te) source to a process chamber using a liquid delivery system (LDS) method. At least one metal-organic (MO) source is supplied to the process chamber using a bubbler method. The Te source and the at least one MO source are deposited on a target material in the process chamber. The target material may be a semiconductor wafer. The at least one MO source may include an antimony (Sb) source.

In other embodiments, supplying the Te source to the process chamber includes supplying a liquid Te source at a controlled flow rate and then evaporating the liquid Te source having the controlled flow rate before supplying the Te source to the process chamber. Supplying the Te source to the process chamber may include supplying the liquid Te source and a pressure control gas to a Te source container and supplying the liquid Te source to a liquid mass flow controller (LMFC) configured to set the controlled flow rate from the Te source container responsive to the pressure control gas.

In other embodiments, supplying the Te source to the process chamber includes supplying the liquid Te source having the controlled flow rate to a vaporizer configured to evaporate the liquid Te source before supplying the Te source to the process chamber and supplying a carrier gas to the vaporizer and to an outlet of the vaporizer. The method may further include supplying a reactive gas to the process chamber. The carrier gas may be argon (Ar) gas and the reactive gas may be ammonia (NH₃) gas. Supplying at least one MO source to the process chamber may include supplying the carrier gas and the MO source to an MO source container, passing the carrier gas through the MO source in the MO source container to evaporate the at least one MO source and providing the evaporated at least one MO source to the process chamber.

In further embodiments, the method further includes supplying an additional tellurium (Te) source to the process chamber using a bubbler method.

In yet other embodiments, a method of fabricating a phase-change material includes supplying a first material to a process chamber using a liquid delivery system (LDS) method. At least one second material is supplied to the process chamber using a bubbler method. The first material and the second material are deposited on a target material.

In further embodiments, an apparatus for fabricating a phase-change material layer includes a process chamber. A first source supplier including a liquid delivery system (LDS) structure is coupled between a tellurium (Te) source container and the process chamber. A second source supplier including a bubbler method structure is coupled between at least one metal organic (MO) source container and the process chamber. The process chamber may be configured to perform a deposition process, the first source supplier may be configured to supply a tellurium (Te) source from the Te source container to the process chamber using a liquid delivery system (LDS) method and the second source supplier may be configured to supply at least one metal oxide (MO) source from the at least one MO source container to the process chamber using a bubbler method.

In yet other embodiments, the at least one MO source container includes an antimony (Sb) source and the Te source container includes a tellerium (TE) source. The at least one MO source container is configured to be coupled to an Sb source supply and the Te source container is configured to be coupled to a Te source supply. The at least one MO source container may be a plurality of MO source containers and the second source supplier may include a separate bubbler method structure coupled between each of the MO source containers and the process chamber.

In further embodiments, the first LDS structure includes a liquid mass flow controller (LMFC) coupled between the Te source container and the process chamber that is configured to control a flow rate of a liquid tellerium (Te) source from the Te source container to the process chamber. A vaporizer is coupled between the LMFC and the process chamber that is configured to evaporate the liquid Te source from the LMFC before it is supplied to the process chamber. The first source supplier may further include a pressure-control gas container coupled to the Te source container. The Te source container may be configured to supply the liquid Te source to the LMFC responsive to a pressure-control gas from the pressure-control gas container. The apparatus may further include a carrier gas container coupled to the vaporizer and to an outlet of the vaporizer that is configured to provide a carrier gas into the vaporizer and into the outlet of the vaporizer. The LDS structure may further include a first drain container selectively coupled between the Te source container and the LMFC and a second drain container selectively coupled between the vaporizer and the process chamber configured to receive residual gases from the LDS structure when a Te source is not being provided from the Te source container to the process chamber.

In other embodiments, the process chamber is configured to perform atomic layer deposition (ALD) and chemical vapor deposition (CVD). The apparatus further includes a reactive gas container coupled to the process chamber. The apparatus may further include a carrier gas container coupled to the MO source container that is configured to provide a carrier gas to the MO source container. The MO source container may be configured to provide the MO source to the process chamber using the bubbler method responsive to the carrier gas. The bubbler method structure may further include a drain container selectively coupled between the MO source container and the process chamber that is configured to receive residual gases from the bubbler method structure when a MO source is not being provided from the MO source container to the process chamber.

In yet further embodiments, the apparatus is configured to provide a MO source to the process chamber using the second source supplier and then provide a Te source to the process chamber using the first supplier after a delay time during an atomic layer deposition (ALD) mode. The apparatus is configured to substantially simultaneously provide the MO source to the process chamber using the second source supplier and provide the Te source to the process chamber using the first supplier during a chemical vapor deposition (CVD) mode. A third source supplier including a bubbler method structure may be coupled between a second tellurium (Te) source container and the process chamber.

### BRIEF DESCRIPTION OF THE DRAWINGS

The foregoing and other features and advantages of the inventive subject matter will be apparent from the more particular description of preferred embodiments of the inventive subject matter, as illustrated in the accompanying drawings in which like reference characters refer to the same parts throughout the different views. The drawings are not necessarily to scale, emphasis instead being placed upon illustrating the principles of the inventive subject matter. In the drawings:

FIG. 1 is a schematic view of an apparatus for fabricating a phase-change material according to some embodiments;

FIG. 2 is a schematic view of an apparatus for fabricating a phase-change material according to other embodiments;

FIG. 3A is a timing diagram showing patterns by which a tellurium (Te) source, an antimony (Sb) source, and a carrier gas (Argon (Ar)) are injected when a phase-change material is deposited by atomic layer deposition (ALD) using the apparatus of FIG. 2 according to some embodiments;

FIG. 3B is a timing diagram showing patterns by which a Te source, an Sb source, and a carrier gas are injected when a phase-change material is deposited by chemical vapor deposition (CVD) using the apparatus of FIG. 2 according to some embodiments;

FIG. 4 is a schematic view of an apparatus for fabricating a phase-change material according to further embodiments;

FIG. 5 is a schematic view of an apparatus for fabricating a phase-change material according to yet other embodiments;

FIG. 6A is a timing diagram showing patterns by which a Te source, an Sb source, and a carrier gas are injected when a phase-change material is deposited by ALD using the apparatus of FIG. 4 according to some embodiments;

FIG. 6B is a timing diagram showing patterns by which a Te source, an Sb source, and a carrier gas are injected when a phase-change material is deposited by CVD using the apparatus of FIG. 4 according to some embodiments;

FIG. 7 is a graph showing vapor-pressure curves of 2-isoprophyl Te and 2-tertbutyl Te;

FIG. 8 is a table showing the reproduction rate of a deposition layer according to some embodiments of a method of supplying a Te source;

FIG. 9 is a circuit diagram of an example of a unit memory cell including a resistive device that may be fabricated by an apparatus for fabricating a phase-change material according to some embodiments;

FIG. 10 is a block diagram of an example of the resistive device that may be included in the unit memory cell of FIG. 9 according to some embodiments;

FIG. 11 is a cross-sectional block diagram of fill types/patterns of a phase-change material that may be used in the resistive device of FIG. 10 according to some embodiments;

FIG. 12 is a schematic view of an apparatus for fabricating a phase-change material according to yet further embodiments;

FIG. 13 is a flowchart illustrating a method of fabricating a phase-change material according to some embodiments; and

FIG. 14 is a detailed flowchart illustrating a step of supplying a Te source to a process chamber using a liquid delivery system (LDS) method in the method of FIG. 13 according to some embodiments.

### DETAILED DESCRIPTION OF THE EMBODIMENTS

Since embodiments of the present inventive subject matter are provided only for structural and functional descriptions of the present inventive subject matter, the inventive subject matter should not be construed as limited to the embodiments set forth herein. Thus, it will be clearly understood by those skilled in the art that the present inventive subject matter may be embodied in different forms and include all variations, equivalents, and substitutes that can realize the spirit of the present inventive subject matter.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Meanwhile, spatially relative terms, such as “between” and “directly between” or “adjacent to” and “directly adjacent to” and the like, which are used herein for ease of description to describe one element or feature's relationship to another element(s) or feature(s) as illustrated in the figures, should be interpreted similarly.

The terminology used herein is for the purpose of describing particular embodiments only and is not intended to be limiting of the inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Unless expressly defined in a specific order herein, respective operations described for embodiments herein may be performed otherwise unless expressly stated otherwise. That is, the respective operations may generally be performed in a specified order, substantially at the same time, or in reverse order.

Hereinafter, an apparatus for and method of fabricating a phase-change material according to embodiments of the inventive subject matter will be described with reference to the appended drawings.

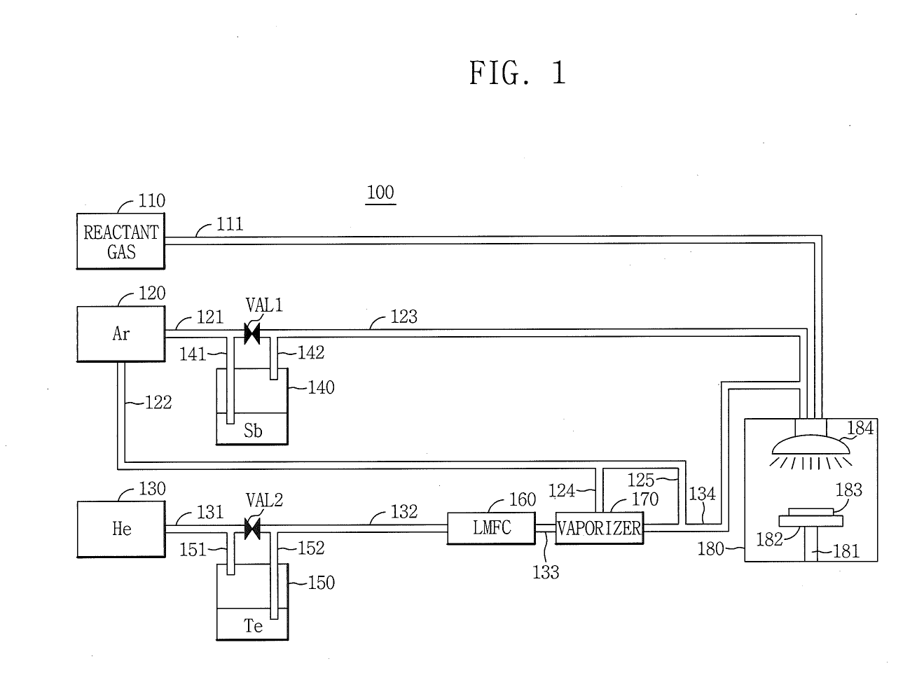

FIG. 1 is a schematic view of an apparatus for fabricating a phase-change material according to some embodiments of the inventive subject matter. Referring to FIG. 1, an apparatus 100 in the illustrated embodiments may include a reactant (reactive) gas container 110, a carrier gas (Argon (Ar)) container 120, a pressure control gas (Helium (He)) container 130, an antimony (Sb) source container 140, a tellurium (Te) source container 150, a liquid mass flow controller (LMFC) 160, a vaporizer 170, a process chamber 180, a first valve VAL1, and a second valve VAL2. Phase-change material sources, a reactive gas, a carrier gas, and a pressure control gas may be supplied to the process chamber 180 through pipes, schematically shown as pipes 111, 121, 122, 123, 131, 132, 133, 134, 141, 142, 151, 152, 124, 125 in the embodiments of FIG. 1.

The pressure control gas container 130, the Te source container 150, the LMFC 160, the vaporizer 170, the second valve VAL2, and pipes 131, 132, 133, 124, 125, 151, and 152 may constitute a first source supplier.

In the first source supplier, the pressure control gas container 130, the Te source container 150, the pipes 131, 132, 151, and 152 and the second valve VAL2 may constitute a Te supply section of the first source supplier.

The Sb source container 140, the first valve VAL1, and the pipes 123, 141, and 142 may constitute a second source supplier. The carrier gas container 120 and the pipes 121 and 122 may constitute a carrier gas supplier. The reactive gas container 110 and the pipe 111 may constitute a reactive gas supplier. The process chamber 180 may include a holder 181, a heater 182, a semiconductor wafer 183, and a shower head 184.

The first source supplier may supply a Te source to the process chamber 180 using a liquid delivery system (LDS) method. As used herein, a liquid delivery system method delivers the Te source to the vaporizer as a liquid and then vaporizes the liquid for delivery to the process chamber 180. The Te source may be 2-isoprophyl Te having a high vapor pressure. The second source supplier may supply at least one metal organic (MO) source to the process chamber 180 using a bubbler method. As used herein, the bubbler method delivers the at least one MO source to the process chamber 180 by passing gas bubbles through a source liquid. The Te source and the at least one MO source may be deposited on a target material in the process chamber 180. The at least one MO source may contain an Sb source. The target material may be a semiconductor substrate.

In the apparatus 100 of FIG. 1, even if an evaporation reaction occurs in the vaporizer 170, argon (Ar) gas may be supplied as a carrier gas through the pipe 124 to the vaporizer 170 and also supplied through the pipe 125 to a pipe 134 through which an evaporated Te source is output.

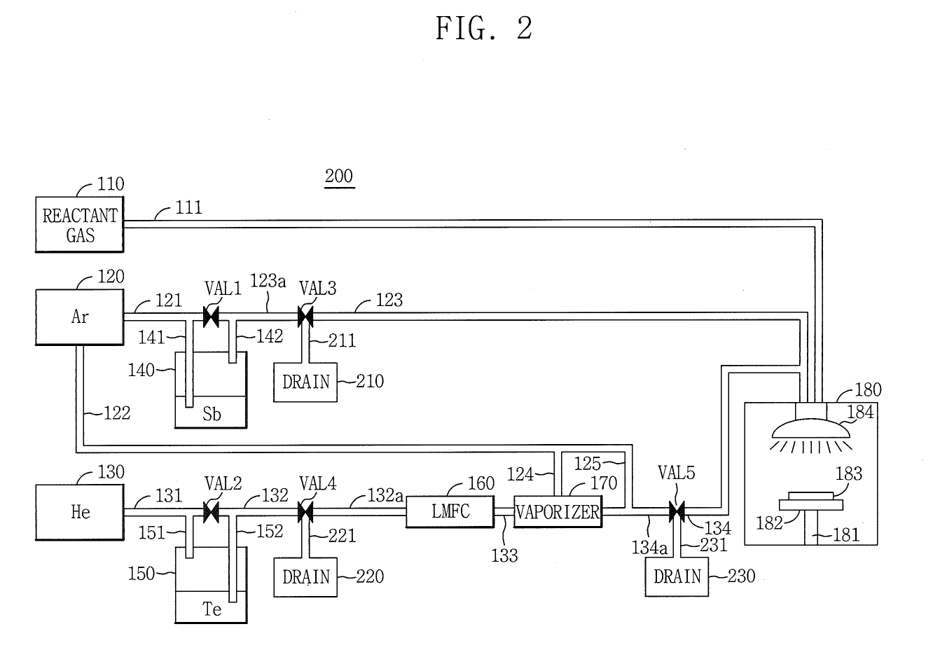

FIG. 2 is a schematic view of an apparatus for fabricating a phase-change material according to other embodiments. Referring to FIG. 2, an apparatus 200 may include a reactive (reactant) gas container 110, a carrier gas container 120, a pressure control gas container 130, an Sb source container 140, a Te source container 150, an LMFC 160, a vaporizer 170, a process chamber 180, a first drain container 210, a second drain container 220, a third drain container 230, a first valve VAL1, a second valve VAL2, a third valve VAL3, a fourth valve VAL4, and a fifth valve VAL5. Phase-change material sources, a reactive source, a carrier gas, and a pressure control gas may be supplied to the process chamber 180 through pipes, a number of which are shown in FIG. 2 as will be discussed below.

The pressure control gas container 130, the Te source container 150, the LMFC 160, the vaporizer 170, the second valve VAL2, the fourth valve VAL4, the second drain container 220, and pipes 131, 132, 132a, 133, 124, 125, 134a, 134, 151, 152, and 221 may be included as a first source supplier in the illustrated embodiments. In the illustrated first source supplier, the pressure control gas container 130, the Te source container 150, the second drain container 220, the pipes 131, 132, 132a, 151, 152, and 221, the second valve VAL2, and the fourth valve VAL4 may be a Te supply section of the first source supplier.

The Sb source container 140, the first drain container 210, the first valve VAL1, the third valve VAL3, and the pipes 123, 123a, 141, 142, and 211 may be a second source supplier. The carrier gas container 120 and the pipes 121 and 122 may be a carrier gas supplier. The reactive gas container 110 and the pipe 111 may be a reactive gas supplier. The process chamber 180 may include a holder 181, a heater 182, a semiconductor wafer 183, and a shower head 184.

The first source supplier may supply a Te source to the process chamber 180 using an LDS method. The Te source may be 2-isoprophyl Te having a high vapor pressure. The second source supplier may supply at least one MO source to the process chamber 180 using a bubbler method. The Te source and the at least one MO source may be deposited on a target material in the process chamber 180. The at least one MO source may contain an Sb source. The target material may be a semiconductor substrate.

In the apparatus 200 of FIG. 2, even if an evaporation reaction occurs in the vaporizer 170, Ar gas may be supplied as a carrier gas through the pipe 124 to the vaporizer 170 and also supplied through the pipe 125 to the pipe 134a through which an evaporated Te source is output from the vaporizer 170.

When it is no longer necessary to supply the Sb source through the pipe 123 to the process chamber 180, the apparatus 200 may control the third valve VAL3 and exhaust the Sb source from the pipe 123 a through the pipe 211 to the first drain container 210. Thus, the apparatus 200 may limit or even prevent particles of the Sb source from being accumulated in the pipe 123a.

Also, when it is no longer necessary to supply the Te source through the pipes 132a and 134 to the process chamber 180, the apparatus 200 may control the fourth valve VAL4 and exhaust the Te source from the pipe 132 through the pipe 221 to the second drain container 220. Furthermore, the apparatus 200 may control the fifth valve VAL5 and exhaust the Te source from the pipe 134a through a pipe 231 to the third drain container 230. Thus, the apparatus 200 may limit or even prevent particles of the Te source from being accumulated in the pipes 132 and 134a.

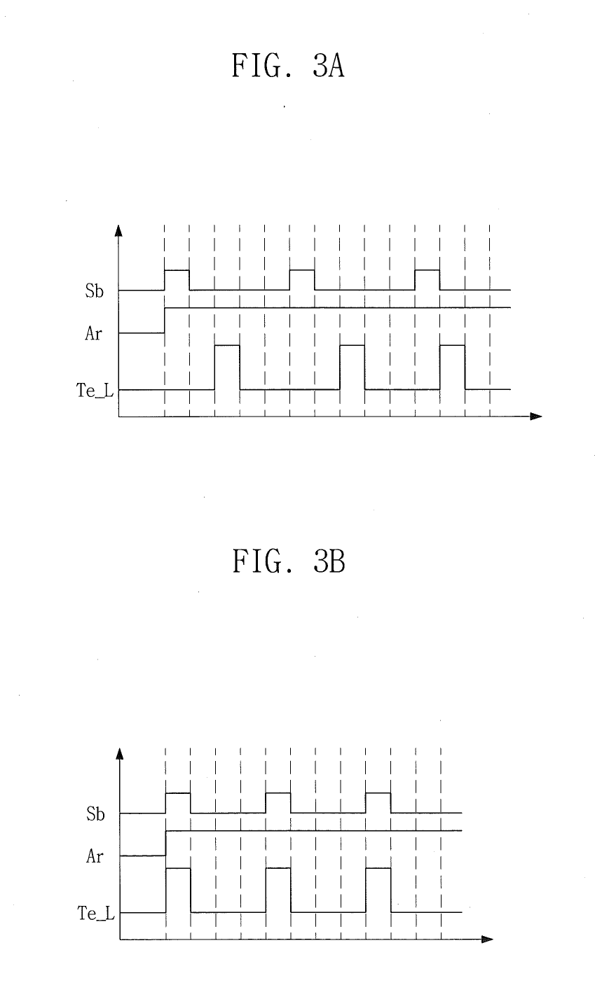

FIG. 3A is a timing diagram showing patterns by (under) which a Te source, an Sb source, and a carrier gas are injected into the process chamber 180 when a phase-change material is deposited by atomic layer deposition (ALD) using the apparatus of FIG. 2 according to some embodiments. In FIG. 3A, an abscissa (x-axis) denotes time, and an ordinate (y-axis) denotes the injected amounts of sources. Referring to FIG. 3A, while the carrier gas (Ar) is being injected during ALD, the Sb source may be initially injected, and a liquid. Te source may subsequently be injected a predetermined time after the injection of the carrier gas.

FIG. 3B is a timing diagram showing patterns by which a Te source, an Sb source, and a carrier gas are injected when a phase-change material is deposited by chemical vapor deposition (CVD) using the apparatus of FIG. 2 according to some embodiments. In FIG. 3B, an abscissa denotes time, and an ordinate denotes the injected amounts of sources. Referring to FIG. 3B, while the carrier gas (Ar) is being injected during CVD, the Sb source and the liquid Te source may be injected at the same time.

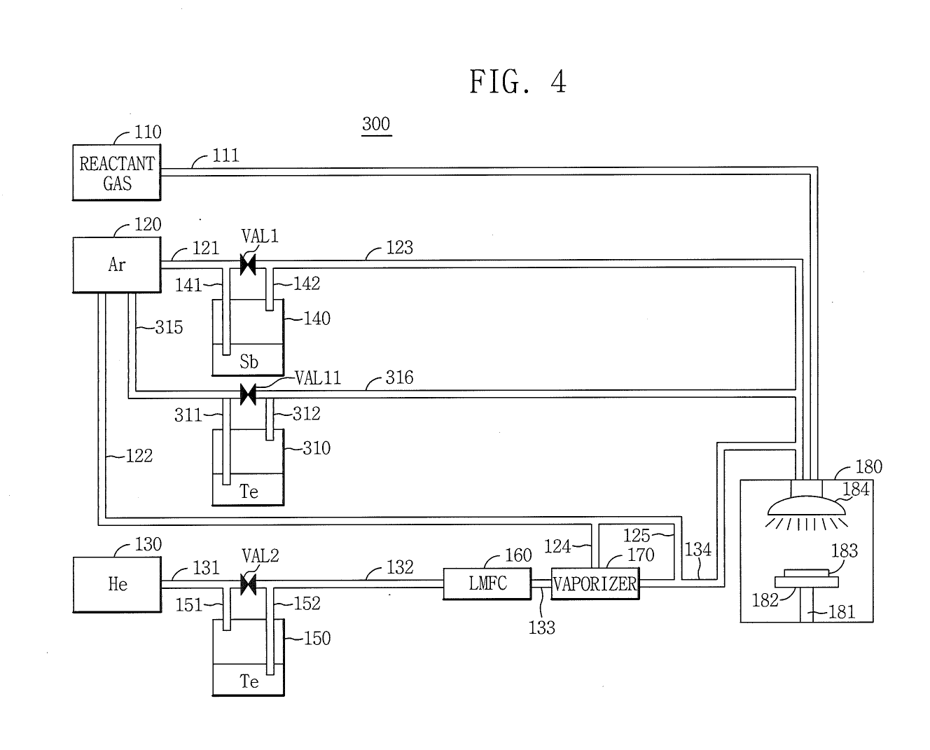

FIG. 4 is a schematic view of an apparatus for fabricating a phase-change material according to other embodiments. Referring to FIG. 4, an apparatus 300 of the illustrated embodiments may include a reactive (reactant) gas container 110, a carrier gas container 120, a pressure control gas container 130, an Sb source container 140, a first Te source container 150, an LMFC 160, a vaporizer 170, a process chamber 180, a second Te source container 310, a first valve VAL1, a second valve VAL2, and a sixth valve VAL11. Phase-change material sources, a reactive gas, a carrier gas, and a pressure control gas may be supplied to the process chamber 180 through pipes, a number of which are shown in FIG. 4 as will be discussed below.

The pressure control gas container 130, the Te source container 150, the LMFC 160, the vaporizer 170, the second valve VAL2, and pipes 131, 132, 133, 124, 125, 151, and 152 may be a first source supplier.

In the first source supplier, the pressure control gas container 130, the Te source container 150, the pipes 131, 132, 151, and 152 and the second valve VAL2 may be a Te supply section of the first source supplier.

The second Te source container 310, the sixth valve VAL11, and pipes 311, 312, and 316 may be a second source supplier. The Sb source container 140, the first valve VAL1, and pipes 123, 141, and 142 may be a third source supplier.

The carrier gas container 120 and pipes 121 and 122 may be a carrier gas supplier. The reactive gas container 110 and a pipe 111 may be a reactive gas supplier. The process chamber 180 may include a holder 181, a heater 182, a semiconductor wafer 183, and a shower head 184.

The first source supplier may supply a first Te source to the process chamber 180 using an LDS method. The second source supplier may supply a second Te source to the process chamber 180 using a bubbler method. The first Te source may be 2-isoprophyl Te having a high vapor pressure, and the second Te source may be 2-tertbutyl Te having a lower vapor pressure than 2-isoprophyl Te. The third source supplier may supply at least one MO source to the process chamber 180 using a bubbler method. In the process chamber 180, the first Te source, the second Te source, and the at least one MO source may be deposited on a target material. The at least one MO source may contain an Sb source. The target material may be a semiconductor substrate.

In the apparatus 300 of FIG. 4, even if an evaporation reaction occurs in the vaporizer 170, Ar gas may be supplied as a carrier gas through a pipe 124 to the vaporizer 170 and also supplied through a pipe 125 even to a pipe 134 through which an evaporated Te source is output from the vaporizer 170.

Thus, the apparatus 300 of FIG. 4 may include both a Te supplier configured to supply a Te source using an LDS method and a Te supplier configured to supply the Te source using a bubbler method.

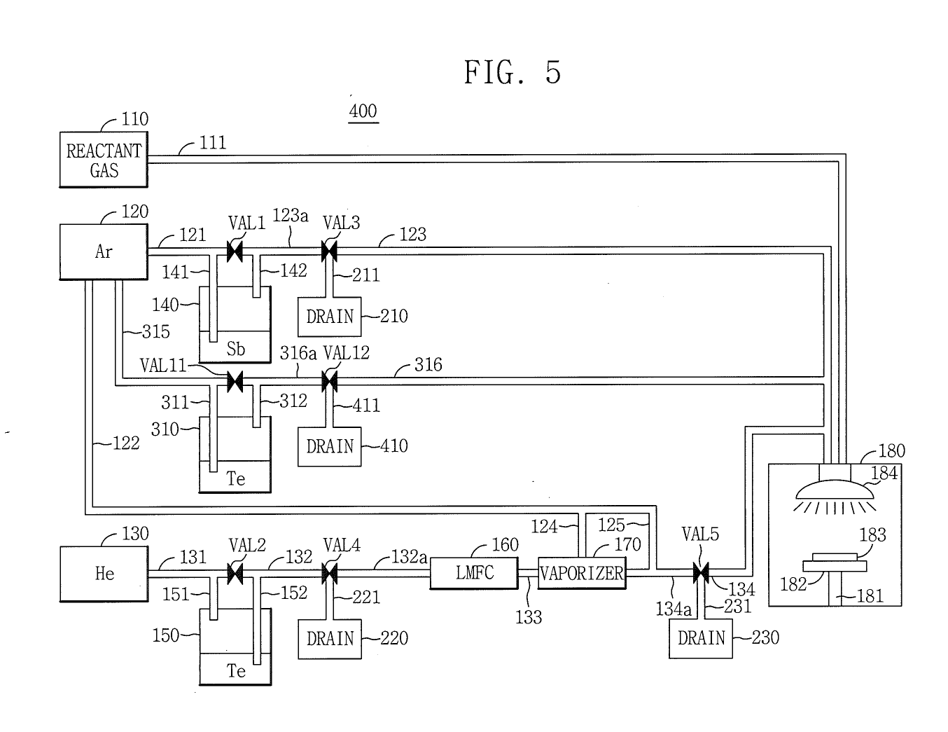

FIG. 5 is a schematic view of an apparatus for fabricating a phase-change material according to further embodiments. Referring to FIG. 5, an apparatus 400 may include a reactive (reactant) gas container 110, a carrier gas container 120, a pressure control gas container 130, an Sb source container 140, a first Te source container 150, a second Te source container 310, an LMFC 160, a vaporizer 170, a process chamber 180, a first drain container 210, a second drain container 220, a third drain container 230, a fourth drain container 410, a first valve VAL1, a second valve VAL2, a third valve VAL3, a fourth valve VAL4, a fifth valve VAL5, a sixth valve VAL11, and a seventh valve VAL12. Phase-change material sources, a reactive (reactant) gas, a carrier gas, and a pressure control gas may be supplied to the process chamber 180 through pipes, a number of which are shown in FIG. 4 as will be discussed below.

The pressure control gas container 130, the first Te source container 150, the LMFC 160, the vaporizer 170, the second valve VAL2, the fourth valve VAL4, the second drain container 220, and pipes 131, 132, 132a, 133, 124, 125, 134a, 134, 151, 152, and 221 may be a first source supplier.

In the first source supplier, the pressure control gas container 130, the first Te source container 150, the second drain container 220, the pipes 131, 132, 132a, 151, 152, and 221, the second valve VAL2, and the fourth valve VAL4 may be a Te supply section of the first source supplier.

The second Te source container 310, the fourth drain container 410, the sixth valve VAL11, the seventh valve VAL12, and the pipes 311, 312, 316, and 316a may constitute a second source supplier.

The Sb source container 140, the first drain container 210, the first valve VAL1, the third valve VAL3, and pipes 123, 123a, 141, 142, and 211 may constitute a third source supplier. The carrier gas container 120 and pipes 121 and 122 may constitute a carrier gas supplier. The reactive (reactant) gas container 110 and a pipe 111 may constitute a reactive (reactant) gas supplier. The process chamber 180 may include a holder 181, a heater 182, a semiconductor wafer 183, and a shower head 184.

The first source supplier may supply a first Te source using an LDS method. The second source supplier may supply a second Te source to the process chamber 180 using a bubbler method. The first Te source may be 2-isoprophyl Te having a high vapor pressure, and the second Te source may be 2-tertbutyl Te having a lower vapor pressure than 2-isoprophyl Te. The third source supplier may supply at least one MO source to the process chamber 180 using a bubbler method. The first Te source, the second Te source, and the at least one MO source may be deposited on a target material in the process chamber 180. The at least one MO source may contain an Sb source. The target material may be a semiconductor substrate.

In the apparatus 400 of FIG. 5, even if an evaporation reaction occurs in the vaporizer 170, Ar gas may be supplied as a carrier gas through a pipe 124 to the vaporizer 170 and also supplied through a pipe 125 even to a pipe 134a through which an evaporated Te source is output from the vaporizer 170.

The apparatus 400 of FIG. 5 may include both a Te supplier configured to supply a Te source using an LDS method and a Te supplier configured to supply the Te source using a bubbler method.

When it is no longer necessary to supply the Sb source through the pipe 123, the apparatus 200 may control the third valve VAL3 and exhaust the Sb source from the pipe 123a through the pipe 211 to the first drain container 210. Thus, the apparatus 200 may limit or even prevent particles of the Sb source from being accumulated in the pipe 123a.

Also, when it is no longer necessary to supply the Te source through pipes 132a and 134 to the process chamber 180, the apparatus 200 may control the fourth valve VAL4 and exhaust the Te source from the pipe 132 through the pipe 211 to the second drain container 220. Furthermore, the apparatus 200 may control the fifth valve VAL5 and exhaust the Te source from the pipe 134a through the pipe 231 to the third drain container 230. Thus, the apparatus 200 may limit or even prevent particles of the Te source from being accumulated in the pipes 132 and 134a.

In addition, when it is no longer necessary to supply the Te source through the pipes 316a and 316 to the process chamber 180, the apparatus 400 may control the seventh valve VAL12 and exhaust the Te source from the pipe 316a through the pipe 411 to the fourth drain container 410. Thus, the apparatus 200 may limit or even prevent particles of the Te source from being accumulated in the pipe 316a.

Thus, the embodiments of FIG. 5 generally include both the dual Te source features of FIG. 4 and the drain features of FIG. 2.

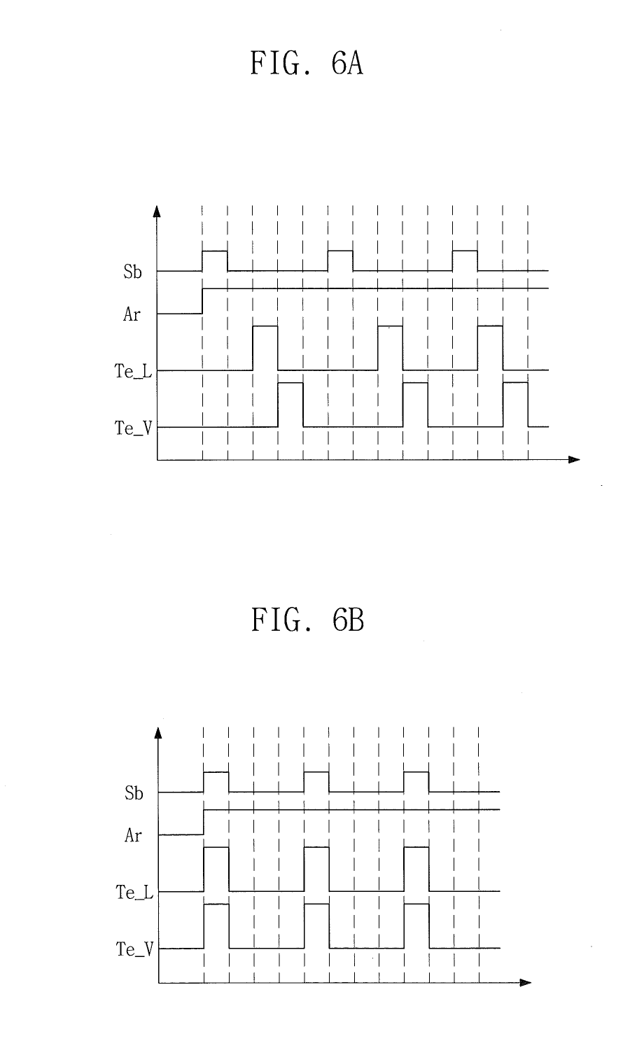

FIG. 6A is a timing diagram showing patterns by which a Te source, an Sb source, and a carrier gas (Ar) are injected when a phase-change material is deposited by ALD using the apparatus of FIG. 4 according to some embodiments. In FIG. 6A, an abscissa denotes time, and an ordinate denotes the injected amounts of sources.

Referring to FIG. 6A, while the carrier gas is being injected during ALD, the Sb source may be initially injected, and a liquid Te source may subsequently be injected, for example, within one hour after completion of the injection of the Sb source, and a gaseous Te source may, for example, be injected within two hours after the injection of the liquid Te source.

FIG. 6B is a timing diagram showing patterns by which a Te source, an Sb source, and a carrier gas are injected when a phase-change material is deposited by CVD using the apparatus of FIG. 4 according to some embodiments. In FIG. 6B, an abscissa denotes time, and an ordinate denotes the injected amounts of sources.

Referring to FIG. 6B, during CVD, the Sb source, a liquid Te source, and a gaseous Te source may be injected substantially simultaneously during injection of the carrier gas.

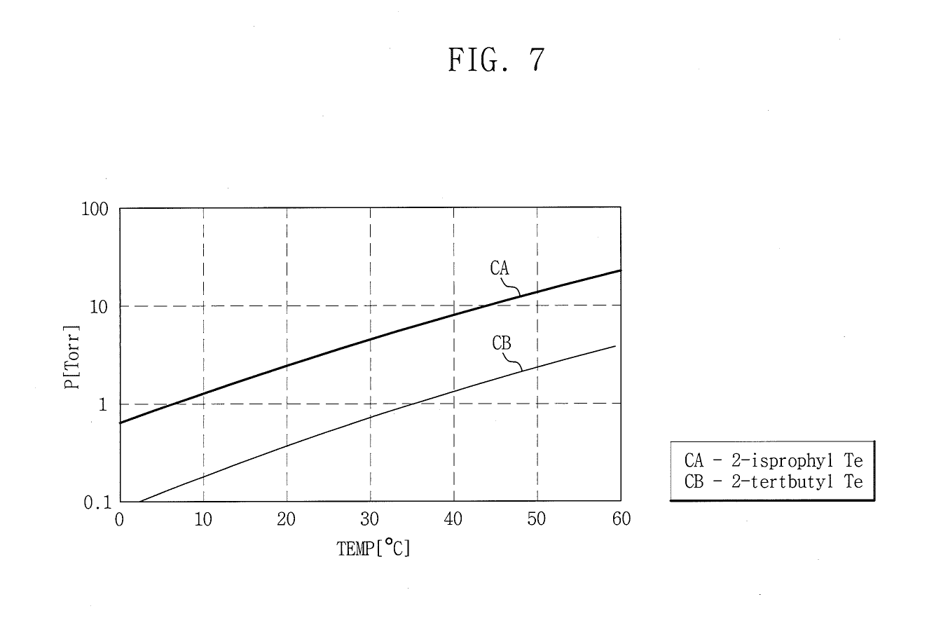

FIG. 7 is a graph illustrating vapor-pressure curves of 2-isoprophyl Te and 2-tertbutyl Te. In FIG. 7, an abscissa denotes temperature, and an ordinate denotes vapor pressure. Also, a first curve CA is a vapor-pressure curve of 2-isoprophyl Te, and a second curve CB is a vapor-pressure curve of 2-tertbutyl Te. Referring to FIG. 7, it may be observed that 2-isoprophyl Te has a higher vapor pressure than 2-tertbutyl Te. Although 2-isoprophyl Te generally has good volatility and high activity, it may be hard to control supply of 2-isoprophyl Te. Also, a deposited 2-tertbutyl Te layer may have a poor film quality. Therefore, in some embodiments, a phase-change material that is a highly reproducible layer may be provided by a deposition process using 2-isoprophyl Te with a high vapor pressure.

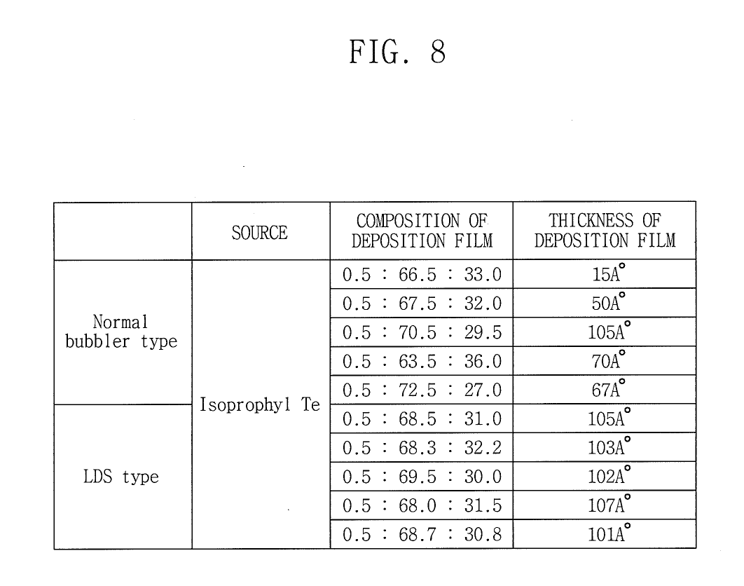

FIG. 8 is a table showing the reproduction rate of a deposition layer according to a method of supplying a Te source when a 2-isoprophyl Te source is used in some embodiments. In the table of FIG. 8, the composition of the deposition layer may refer to composition rates of germanium (Ge), Sb, and Te. For example, a deposition layer in the lowest row of the table contains 0.5% by weight Ge, 68.7% Sb, and 30.8% Te.

Referring to FIG. 8, when a 2-isoprophyl Te source is supplied using an LDS method, deposition layers are shown that have a uniform thicknesses of 105 Å, 103 Å, 102 Å, 107 Å, and 101 Å. Thus, it can be seen that when the 2-isoprophyl Te source is supplied using the LDS method, a highly reproducible deposition layers may be formed in some embodiments. Conversely, when the 2-isoprophyl Te source is supplied using a bubbler method, deposition layers are shown as having non-uniform thicknesses of 15 Å, 50 Å, 105 Å, 70 Å, and 67 Å. Thus, it can be seen that when a 2-isoprophyl Te source is supplied using a bubbler method, a highly reproducible deposition layer may not be provided.

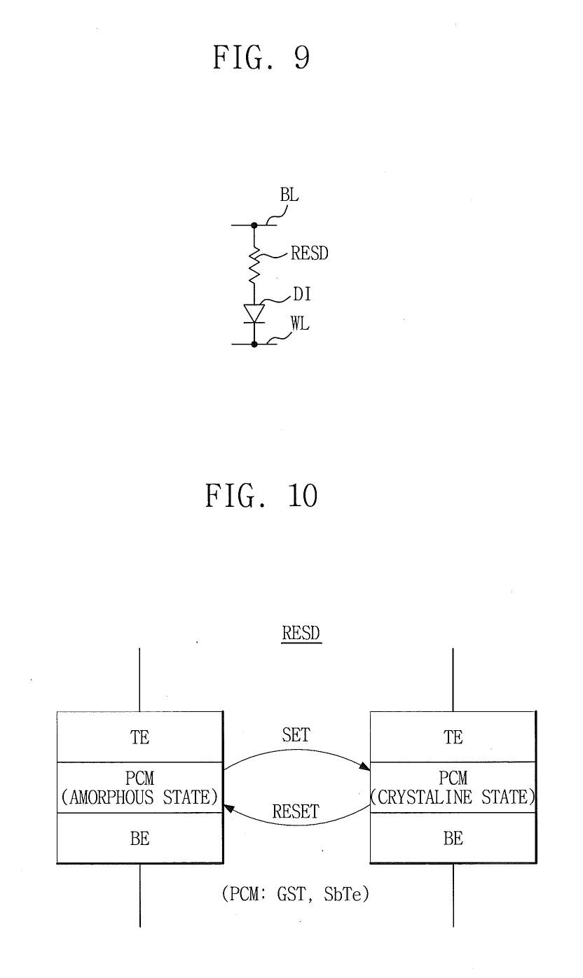

FIG. 9 is a circuit diagram of an example of a unit memory cell including a resistive device fabricated by an apparatus for fabricating a phase-change material according to some embodiments. Referring to FIG. 9, a unit memory cell may include a resistive device RESD having one terminal connected to a bit line BL and a diode D1 coupled between the resistive device RESD and a word line WL.

FIG. 10 is a diagram of an example of the resistive device of FIG. 9. Referring to FIG. 10, a variable resistive device RESD may include a top electrode TE, a bottom electrode BE, and a phase-change material (GeSbTe (GST) or SbTe) disposed between the top and bottom electrodes TE and BE. The phase-change material may be put into an amorphous state or crystalline state and have a variable resistance (depending on its state) responsive to an applied temperature and heating time setting the state.

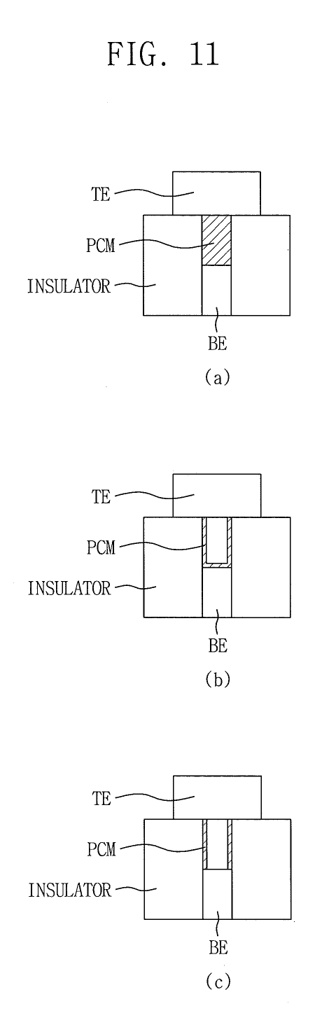

FIG. 11 is a diagram of examples of fill types (patterns) of a phase-change material in the resistive device of FIG. 10. FIG. 11A shows a phase-change material PCM completely filled between a top electrode TE and a bottom electrode BE. FIG. 11B shows an insulator disposed between a top electrode TE and a bottom electrode BE and a phase-change material PCM deposited on lateral and bottom surfaces of the insulator. FIG. 11C shows an insulator disposed between a top electrode TE and a bottom electrode BE and a phase-change material PCM deposited on a lateral surface of the insulator.

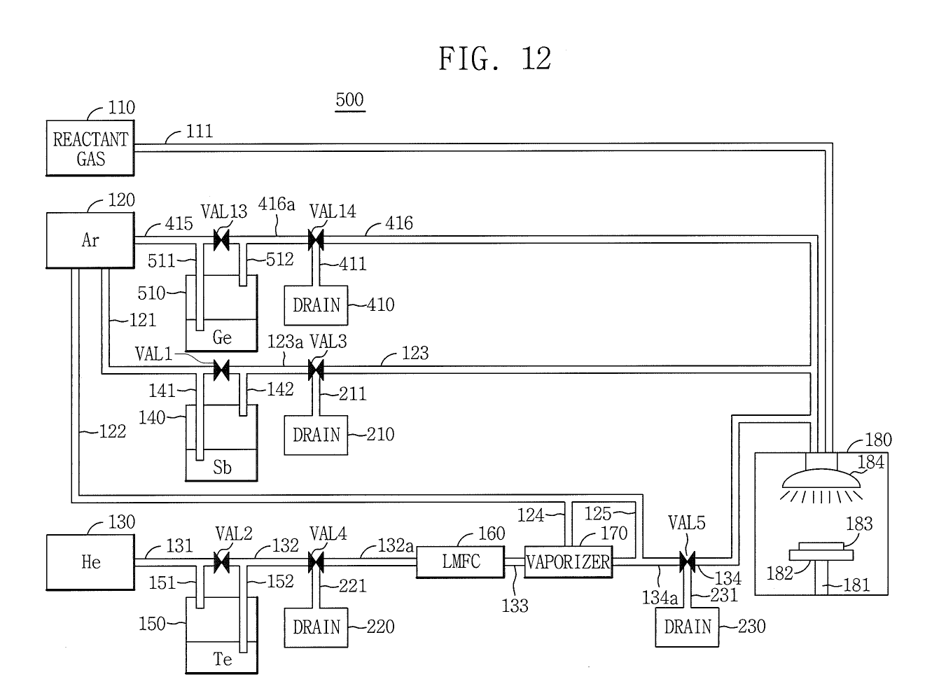

FIG. 12 is a schematic view of an apparatus for fabricating a phase-change material according to further embodiments. Referring to FIG. 12, an apparatus 500 may include a reactive (reactant) gas container 110, a carrier gas container 120, a pressure control gas container 130, an Sb source container 140, a Te source container 150, a Ge source container 510, an LMFC 160, a vaporizer 170, a process chamber 180, a first drain container 210, a second drain container 220, a third drain container 230, a fourth drain container 410, a first valve VAL1, a second valve VAL2, a third valve VAL3, a fourth valve VAL4, a fifth valve VAL5, an eighth valve VAL13, and a ninth valve VAL14. Phase-change material sources, a reactive (reactant) gas, a carrier gas, and a pressure control gas may be supplied to the process chamber 180 through pipes, a number of which are shown in FIG. 12 as will be discussed below.

The pressure control gas container 130, the Te source container 150, the LMFC 160, the vaporizer 170, the second valve VAL2, the fourth valve VAL4, the second drain container 220, and the pipes 131, 132, 132a, 133, 124, 125, 134a, 134, 151, 152, and 221 may constitute a first source supplier.

In the first source supplier, the pressure control gas container 130, the Te source container 150, the second drain container 220, the pipes 131, 132, 132a, 151, 152, and 221, the second valve VAL2 and the fourth valve VAL4 may constitute a Te supply section of the first source supplier.

The Sb source container 140, the first drain container 210, the first valve VAL1, the third valve VAL3, and pipes 123, 123a, 141, 142, and 211 may constitute a second source supplier. The Ge source container 510, the fourth drain container 410, the eighth valve VAL13, the ninth valve VAL14, and pipes 511, 512, 416, and 416a may constitute a third source supplier.

The carrier gas container 120 and pipes 121 and 122 may constitute a carrier gas supplier. The reactive gas container 110 and a pipe 111 may constitute a reactive gas supplier. The process chamber 180 may include a holder 181, a heater 182, a semiconductor wafer 183, and a shower head 184.

The first source supplier may supply a Te source to the process chamber 180 using an LDS method. The Te source may be 2-isoprophyl Te with a high vapor pressure. The second source supplier may supply an Sb source to the process chamber 180 using a bubbler method. The third source supplier may supply a Ge source to the process chamber 180 using a bubbler method. In the process chamber 180, the first Te source, the Ge source, and the Sb source may be deposited on a target material. The target material may be a semiconductor substrate. Thus, the apparatus 500 of FIG. 12 generally corresponds to the apparatus of FIG. 2 with the additional feature of the third source supplier.

In the apparatus 500 of FIG. 12, even if an evaporation reaction occurs in the vaporizer 170, Ar gas may be supplied as a carrier gas through the pipe 124 to the vaporizer 170 and also supplied through the pipe 125 to the pipe 134a through which an evaporated Te source is output from the vaporizer 170.

As described above, when it is no longer necessary to supply sources through pipes to the process chamber 180, the apparatus 500 may control valves and exhaust the sources from the pipes to drain containers. Thus, the apparatus 500 may limit or even prevent particles of the sources from being accumulated in the pipes.

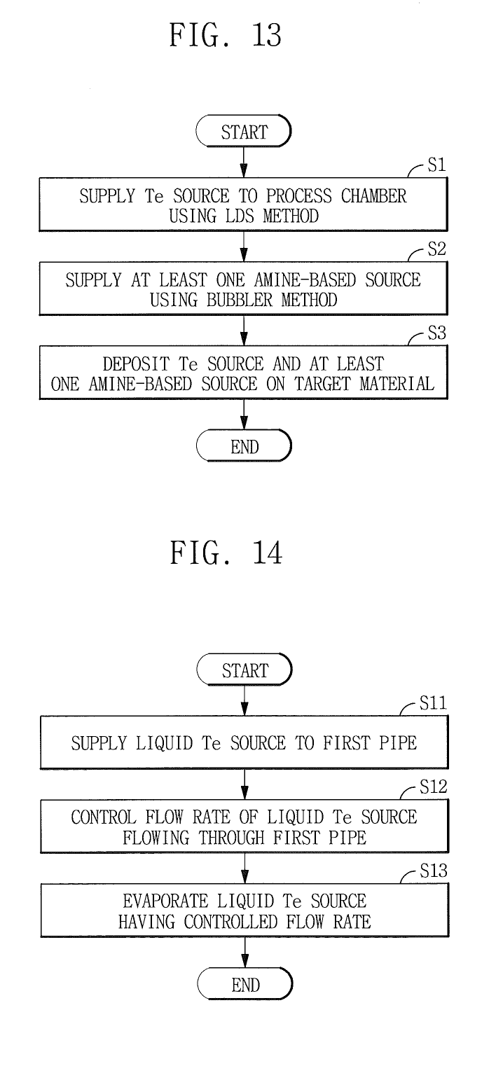

FIG. 13 is a flowchart illustrating a method of fabricating (forming) a phase-change material according to some embodiments. Referring to FIG. 13, the method of fabricating the phase-change material according to the embodiments of FIG. 13 may include the following steps.

1) A Te source may be supplied to a process chamber using an LDS method (S1).

2) At least one MO source may be supplied to the process chamber using a bubbler method (S2).

3) The Te source and the at least one MO source may be deposited on a target material in the process chamber (S3).

FIG. 14 is a detailed flowchart illustrating operations for supplying the Te source to the process chamber using the LDS method at item S1 of FIG. 13 according to some embodiments. Referring to FIG. 14, the operation of supplying the Te source to the process chamber using the LDS method may include the following:

1) A liquid Te source may be supplied to a first pipe (S11).

2) The flow rate of the liquid Te source flowing through the first pipe may be controlled (S12).

3) The liquid Te source having the controlled flow rate may be evaporated (S13).

The above embodiments of the inventive subject matter describe an apparatus for and method of fabricating a phase-change material using a source supplier configured to supply a Te source to a process chamber using an LDS method and a source supplier configured to supply at least one MO source (such as an Sb source) to the process chamber using a bubbler method. However, the present inventive subject matter may be applied to an apparatus for fabricating a phase-change material, which includes a source supplier configured to supply any suitable first source to a process chamber using an LDS method and a source supplier configured to supply any suitable second source to the process chamber using a bubbler method.

The present inventive subject matter may be applied to a semiconductor fabrication apparatus, particularly, an apparatus of fabricating a phase-change material, as described with reference to embodiments of forming a memory device.

According to some embodiments, the apparatus for and method of fabricating a phase-change material may adopt a first source supplier configured to supply a Te source to a process chamber using an LDS method and a second source supplier configured to supply an Sb source to the process chamber using a bubbler method so that a phase-change material having a good film quality may be fabricated using a Te source having a high vapor pressure and an MO source.

Some embodiments of the inventive subject matter provide an apparatus for fabricating a phase-change material.

Some embodiments of the inventive subject matter also provide an apparatus for fabricating a phase-change material, which may be capable of fabricating a phase-change material having a good film quality using a tellurium (Te) source having a high vapor pressure and a metal organic (MO) source.

Some embodiments of the inventive subject matter also provide a method of fabricating a phase-change material, which may fabricate a phase-change material having a good film quality using a Te source having a high vapor pressure and an MO source.

In accordance with an aspect of the inventive subject matter, an apparatus for fabricating a phase-change material includes a process chamber in which a deposition process is performed, a first source supplier, and a second supplier.

The first source supplier supplies a Te source to the process chamber using a liquid delivery system (LDS) method. The second source supplier supplies at least one MO source to the process chamber using a bubbler method.

The at least one MO source may contain an antimony (Sb) source.

The second source supplier may include at least one sub-supplier configured to supply each of the MO sources to the process chamber.

The second source supplier may include: a first sub-supplier configured to supply an Sb source to the process chamber; and a second sub-supplier configured to supply a germanium (Ge) source to the process chamber.

The first source supplier may include a Te supply package, a liquid mass flow controller (LMFC), and a vaporizer.

The Te supply package may supply a liquid Te source to a first pipe. The LMFC may control the flow rate of a liquid flowing through the first pipe. The vaporizer may evaporate the liquid Te source output from the LMFC.

The Te source package may include a pressure-control gas, a second pipe, and a Te source container. The pressure-control gas container may contain a pressure control gas. The second pipe may be connected to the pressure control gas container. The Te source container may receive the pressure control gas through the second pipe and supply a Te source to the first pipe using the pressure control gas.

The pressure control gas may be helium (He) gas.

A carrier gas may be injected to the vaporizer and a second pipe through which an evaporated Te source is output.

The carrier gas may be argon (Ar) gas.

The apparatus may fabricate the phase-change material using atomic layer deposition (ALD) or chemical vapor deposition (CVD).

The second source supplier may include an Sb source container configured to receive a carrier gas through a first pipe, evaporate an Sb source using the carrier gas, and supply the evaporated Sb source through a second pipe to the process chamber.

In accordance with another aspect of the inventive subject matter, an apparatus for fabricating a phase-change material includes a process chamber in which a deposition process is performed, a first source supplier, a second source supplier, and a third source supplier.

The first source supplier may supply a first Te source to the process chamber using a LDS method, and the second source supplier may supply a second Te source to the process chamber using a bubbler method. The third source supplier may supply at least one MO source to the process chamber using the bubbler method.

In accordance with still another aspect of the inventive subject matter, a method of fabricating a phase-change material includes supplying a Te source to a process chamber using a LDS method, supplying at least one MO source to the process chamber using a bubbler method, and depositing the Te source and the at least one MO source on a target material.

The supplying of the Te source to the process chamber may include supplying a liquid Te source to a first pipe, controlling the flow rate of the liquid Te source flowing through the first pipe, and evaporating the liquid Te source having the controlled flow rate.

In accordance with yet another aspect of the inventive subject matter, a method of fabricating a phase-change material includes supplying a first material to a process chamber using a LDS method, supplying at least one second material to the process chamber using a bubbler method, and depositing the first material and the second material on a target material.

The foregoing is illustrative of embodiments and is not to be construed as limiting thereof. Although a few embodiments have been described, those skilled in the art will readily appreciate that many modifications are possible in embodiments without materially departing from the novel teachings and advantages. Accordingly, all such modifications are intended to be included within the scope of this inventive concept as defined in the claims. In the claims, means-plus-function clauses are intended to cover the structures described herein as performing the recited function, and not only structural equivalents but also equivalent structures. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims.

1-25. (canceled)

26. An apparatus for fabricating a phase-change material layer, the apparatus comprising:
a process chamber;
a first source supplier including a liquid delivery system (LDS) structure coupled between a tellurium (Te) source container and the process chamber; and
a second source supplier including a bubbler method structure coupled between at least one metal organic (MO) source container and the process chamber.

27. The apparatus of claim 26, wherein the process chamber is configured to perform a deposition process, the first source supplier is configured to supply a tellurium (Te) source from the Te source container to the process chamber using a liquid delivery system (LDS) method and the second source supplier is configured to supply at least one metal oxide (MO) source from the at least one MO source container to the process chamber using a bubbler method.

28. The apparatus of claim 26, wherein the at least one MO source container includes an antimony (Sb) source and the Te source container includes a tellerium (TE) source and wherein the at least one MO source container is configured to be coupled to an Sb source supply and the Te source container is configured to be coupled to a Te source supply.

29. The apparatus of claim 26, wherein the at least one MO source container comprises a plurality of MO source containers and wherein the second source supplier includes a separate bubbler method structure coupled between each of the MO source containers and the process chamber.

30. The apparatus of claim 26, wherein the first LDS structure includes:
a liquid mass flow controller (LMFC) coupled between the Te source container and the process chamber that is configured to control a flow rate of a liquid tellerium (Te) source from the Te source container to the process chamber; and
a vaporizer coupled between the LMFC and the process chamber that is configured to evaporate the liquid Te source from the LMFC before it is supplied to the process chamber.

31. The apparatus of claim 30, wherein the first source supplier further comprises a pressure-control gas container coupled to the Te source container and wherein the Te source container is configured to supply the liquid Te source to the LMFC responsive to a pressure-control gas from the pressure-control gas container.

32. The apparatus of claim 30, wherein the apparatus further comprises a carrier gas container coupled to the vaporizer and to an outlet of the vaporizer that is configured to provide a carrier gas into the vaporizer and into the outlet of the vaporizer.

33. The apparatus of claim 30, wherein the LDS structure further comprises a first drain container selectively coupled between the Te source container and the LMFC and a second drain container selectively coupled between the vaporizer and the process chamber configured to receive residual gases from the LDS structure when a Te source is not being provided from the Te source container to the process chamber.

34. The apparatus of claim 26, wherein the process chamber is configured to perform atomic layer deposition (ALD) and chemical vapor deposition (CVD) and wherein the apparatus further includes a reactive gas container coupled to the process chamber.

35. The apparatus of claim 26, wherein the apparatus further comprises a carrier gas container coupled to the MO source container that is configured to provide a carrier gas to the MO source container and wherein the MO source container is configured to provide the MO source to the process chamber using the bubbler method responsive to the carrier gas.

36. The apparatus of claim 35, wherein the bubbler method structure further comprises a drain container selectively coupled between the MO source container and the process chamber configured to receive residual gases from the bubbler method structure when a MO source is not being provided from the MO source container to the process chamber.

37. The apparatus of claim 26, wherein the apparatus is configured to provide a MO source to the process chamber using the second source supplier and then provide a Te source to the process chamber using the first supplier after a delay time during an atomic layer deposition (ALD) mode and to substantially simultaneously provide the MO source to the process chamber using the second source supplier and provide the Te source to the process chamber using the first supplier during a chemical vapor deposition (CVD) mode.

38. The apparatus of claim 26, further comprising a third source supplier including a bubbler method structure coupled between a second tellurium (Te) source container and the process chamber.
